(19) United States
(12) Patent Application Publication
(10) Pub. No.: US 2024/0192913 A1
(43) Pub. Date: Jun. 13, 2024

(54) BUILDING SLIDING DOOR SYSTEM WITH ELECTRONIC DISPLAY DEVICE WHICH EXTENDS OVER THE EDGES

(71) Applicant: Inventio AG, Hergiswil (CH)

(72) Inventor: Jonas Vonaesch, Luzern (CH)

(21) Appl. No.: 18/555,267

(22) PCT Filed: Apr. 7, 2022
(86) PCT No.: PCT/EP2022/059235

§ 371 Date: Oct. 13, 2023

(30) Foreign Application Priority Data
Apr. 20, 2021 (EP) 21169295.9

(51) Int. Cl. G06F 3/147; E05F 15/632

(52) U.S. Cl. CPC G06F 3/147; E05F 15/632; E05Y 2201/406; E05Y 2400/32; E05Y 2400/44; E05Y 2400/822; E05Y 2900/14

(57) ABSTRACT

A building sliding door system has a frame structure with passage, door frame and wall shell regions, and a sliding door is movable in the frame structure along a movement axis between closed and open positions. The wall shell region at least partially receives the sliding door in the open position. A door leaf has an end face facing the passage region and extending transversely to the movement axis. A drive unit and a control device move the sliding door. A display device is arranged in a vertical section of the door and is connected to the control device. The display device has a user interface that extends between a region of the end face and a region of the door across the edge of the door. The control device controls the display device to display information on the door leaf side and/or on the end face.

### FIELD

The technology described herein relates in general to the technical equipment of a building. Exemplary embodiments of the technology relate in particular to the building technical equipment for separating access to the building or to a building interior, and a method for operating the building technical equipment.

### BACKGROUND

Buildings can be equipped in a very wide variety of ways to separate access to the building or, within the building, access to an interior space within the building. In a building, the separation is often accomplished by doors. A door can be designed as a single-action door with a movable door leaf which is pivotably fastened to the door frame (jamb, doorframe lining) by two or more hinges (door hinges) or as a folding door in which one or more door leaves are divided by hinge bands or flexible strips into several parts which fold out of the closing plane during opening. Sliding doors are also known which are fastened to the frame with runner rails in which the door leaf is hung or inserted and can be displaced laterally. EP 2 876 241 B1 describes, for example, a sliding door which is displaceable within a frame structure between a closed position and an open position. In the closed position, the sliding door is flush with the wall surrounding it, and in the open position, a recess in the wall receives the sliding door at least partially.

The systems mentioned relate to different demands made of building doors and their respective embodiments in a building. In addition to these known requirements, there are further requirements, for example due to changing lifestyles or living conditions (e.g., dense living in apartments in a city), a need for increased security and increasing automation of and in buildings. There is therefore a need for a technology that enables further automation of the operation of a building door.

### SUMMARY

One aspect of such a technology relates to a building sliding door system that separates a first building region from a second building region. The building sliding door system has a frame structure which has a door frame region, a passage region and a wall shell region. A sliding door can be moved in the frame structure between a closed position and an open position along a movement axis. The sliding door has an end face and a door leaf, wherein the wall shell region at least partially accommodates the sliding door in the open position. The end face points in the direction of the passage region and extends transversely to the movement axis. The door leaf extends from the end face substantially parallel to the movement axis. An electromechanical drive unit and a control device are designed to move the sliding door. In addition, an electronic display device is provided, which is arranged in a fixed vertical section on the sliding door and is connected to the control device. The display device has a user interface which extends across edges between a fixed region of the end face and a fixed region of the door leaf. The control device is designed to control the display device in order to display information, wherein the information display takes place on the door leaf side and/or on the end face.

Another aspect relates to a method for operating the building sliding door system. According to the method, the electronic display device for an information display is controlled by the control device in such a way that the information display takes place on the door leaf side and/or on the end face.

The technology described here creates a building sliding door system in which the electronic display device, or information presented by it, can be perceived by a user in the closed position of the sliding door and in the open position thereof. In the (completely) open position, the door leaf side part of the display device can project completely or partially into the wall shell region and be concealed by it, while the end face part of the display device remains visible and information can be displayed there.

In one exemplary embodiment, the control device controls the display device as a function of a determined position of the sliding door, in particular as a function of a distance D between the end face and the door frame region, wherein the information display takes place on the door leaf side in the closed position of the sliding door, on the end face in the open position, and on the door leaf side and/or on the end face in an intermediate position. The information display can take place, for example, during opening in such a way that the information to be presented (from the point of view and perception of a user standing in front of the sliding door), starting from a door leaf side presentation, is moved in a quasi-flowing manner into the end face presentation, in order to enable the best possible perception by the user during opening.

In one exemplary embodiment, the movement into the end face presentation takes place when the distance D reaches or exceeds a defined threshold value. The threshold value can be selected in a building- and/or application-specific manner. In one exemplary embodiment, the threshold value is about 80%, i.e. the sliding door is 80% open. In one exemplary embodiment, when the threshold value is reached, a flow mode begins; at a threshold value of approximately 80%, the information display is therefore only shifted from the display on the door leaf side in the direction of the end face when the sliding door has already been opened relatively far. The information can therefore be perceived by the user even when the sliding door is essentially completely open.

Various technologies can be used to determine the position of the sliding door. In one embodiment, a rotary encoder present in the electromechanical drive unit can be used, which detects an angle change when there is a movement of the sliding door caused by the drive unit. The control device is configured to determine the position of the sliding door, in particular the distance D between the end face and the door frame region, from the change in angle. In another exemplary embodiment, a sensor unit (e.g. a 3D camera) arranged on the sliding door can be used, which is connected to the control device and determines the distance D in order to determine from the distance D a position of the sliding door.

Depending on the type or use of the building or of the sliding door system, the display device can have at least one further device for a further functionality. In one embodiment, a visible (multi-functional) unit can thus be arranged on the sliding door only at a single location, thereby facilitating installation, maintenance and cleaning. The further devices can include in particular a video camera for a door peephole function and/or for detecting an optical code, a radio unit for detecting a proof of authorization and/or for communicating with a mobile telephone of a user, a loudspeaker, a proximity sensor for detecting an approaching user, and/or an LED lighting device for illuminating the display device and/or an environment of the sliding door. The person skilled in the art will recognize that one or more of these devices can be arranged outside the display device; for example, a video camera can be arranged at a typical head height/face height of a standing adult person.

### DESCRIPTION OF THE DRAWINGS

Various aspects of the improved technology are described in greater detail below in conjunction with the drawings with reference to exemplary embodiments. In the figures, identical elements have identical reference signs. In the drawings:

FIG. 1 shows a schematic perspective representation of an exemplary embodiment of a building sliding door system with a partly open sliding door and a display device arranged thereon;

FIGS. 2A-2D show schematic representations of the display device according to FIG. 1 with an exemplary information display;

FIG. 3 shows a flow chart of a second embodiment of a method for operating the building sliding door system; and

FIGS. 4A-4C show schematic representations of the sliding door according to FIG. 1 in different positions (closed position, partially open position, fully open position).

### DETAILED DESCRIPTION

FIG. 1 is a schematic perspective representation of an exemplary embodiment of a building sliding door system 1 for separating a first building zone 21 from a second building zone 22. In an exemplary embodiment, the building sliding door system 1 can be a part of a building inner wall, for example in an apartment building, it can separate the private interior region of an apartment (for example, the first zone 21) from a (non-private) exterior region (for example, a hallway or stairwell) (for example, the second zone 22). Similarly, the building sliding door system 1 can be used, for example, in a building interior wall in an office building, hotel, or the like; in a hotel, the building sliding door system 1 can separate two adjacent rooms, for example. In another exemplary embodiment, the building sliding door system 1 can be a part of a building exterior wall, for example it can separate the interior region (for example, the first zone 21) of a non-public building (for example, an apartment building, hotel, business building, or the like) from the public exterior region (for example, a street or a public space) (for example, the second zone 22). In the following, the first zone 21 is referred to as the interior zone 21, and the second zone 22 is referred to as the exterior zone 22.

In the shown exemplary embodiment, the building sliding door system 1 has a frame structure 2 in which different regions can be established. For illustration and differentiability, these regions are referred to below as the door frame region 2a, passage region 2b and wall shell region 2c. The building sliding door system 1 also includes a sliding door 4 which can be moved within the frame structure 2 along a movement axis x between a closed position and an open position. In the closed position, the sliding door 4 closes the passage region 2b, and in the open position, the sliding door 4 opens the passage region 2b completely or partially so that, for example, a person, a pet or a robot can pass from one of the zones 21, 22 into the other zone. In the partially open position shown in FIG. 1, an end face 30 of the sliding door 4 has a distance D from the door frame region 2a. Further details on the mechanical construction of the frame structure 2 and the sliding door 4 are given elsewhere in the present description.

In FIG. 1, it is indicated that the building sliding door system 1 includes electronic and electromechanical system components and is connected to a building control system 20 (BM). In one exemplary embodiment, the building sliding door system 1 is communicatively connected to the building control system 20 (BM). An electrical interface device 16, a control device 12 (DC), a drive unit 14 (M), a sensor unit 18 and an electronic display device 10 are shown as exemplary system components of the building sliding door system 1. The control device 12 controls the opening and closing of the sliding door 4 and stores, at least for a defined period of time, a current operating state of the sliding door 4 in a storage device 12a (D %). This includes, inter alia, information about the distance D of the end face 30 from the door frame region 2a, wherein the distance D can vary between zero and a maximum distance Dmax (0≤D≤Dmax). In the control device 12, information is thus present which indicates whether the sliding door 4 is closed (D=0), is completely open (D=Dmax), or is partially open (0<D<Dmax). The distance D may be indicated as an absolute value (length, e.g., in centimeters) or as a percentage value. Exemplary embodiments of how this distance D can be determined are indicated elsewhere in the present description.

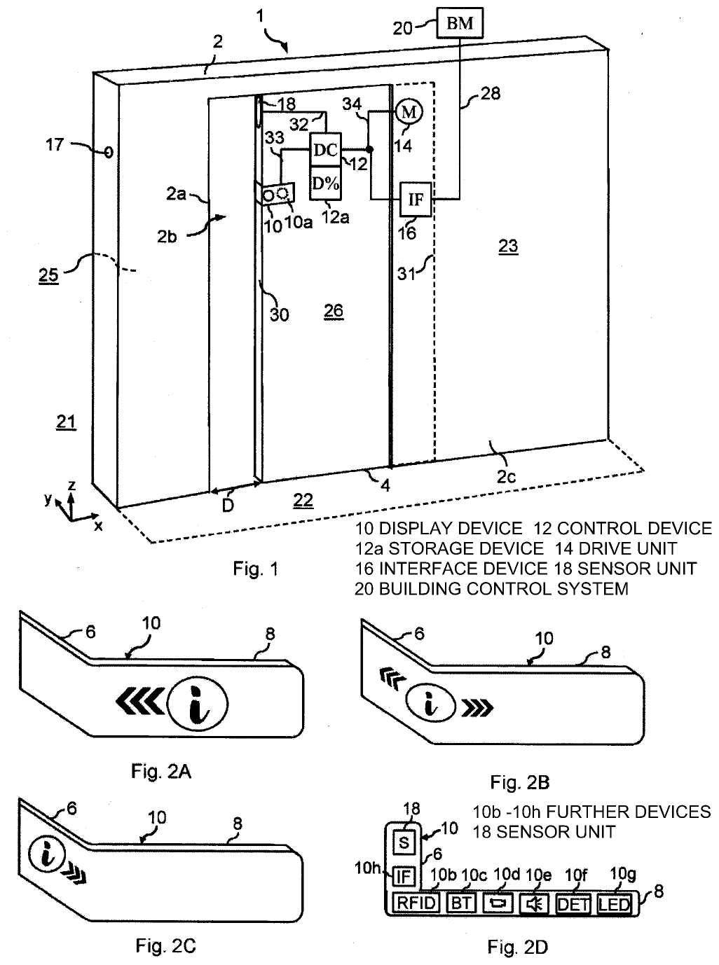

In the situation shown in FIG. 1, the technology described herein can be used in an advantageous manner. Summarized briefly and by way of example, the technology described here makes it possible for the electronic display device 10 or information presented by it to be perceived by a user, in the closed position and in the open position. For this purpose, the display device 10 is arranged in a fixed vertical section (e.g. between about 1 m and 1.5 m) on the sliding door 4. A user interface 10a of the display device 10 extends across the edges between a fixed region of the end face 30 and a fixed region of a door leaf 26 of the sliding door 4. Since a cavity in the wall shell region 2c receives the sliding door 4 in the (completely) open position, the door leaf side part of the display device 10 can project completely or partially into the wall shell region 2c and be concealed by it, while the end face part of the display device 10 can be seen and information can be displayed there. The control device 12 accordingly controls the display device 10 in order to display information via an electrical connection 33. In one exemplary embodiment, the control device 12 controls the display device 10 as a function of a determined position of the sliding door 4, in particular as a function of the distance D, wherein the information display takes place on the door leaf side in the closed position of the sliding door 4, on the end face in the open position, and on the door leaf side and/or on the end face in an intermediate position. The information display can take place for example during opening in such a way that the information to be displayed, starting from a door leaf side presentation, is moved in a quasi-flowing manner into the end face presentation, enabling it to be perceived as well as possible by the user. In one exemplary embodiment, the movement into the end face presentation takes place when the distance D reaches or exceeds a defined threshold value. Exemplary display options are shown in FIG. 2A-FIG. 2C. In the present description, the terms “flow,” “move,” “press,” “flow process,” and “flow mode” are used to describe and characterize a process in particular from the view and perception of a user.

Schematic representations of an embodiment of the display device 10 are shown in FIG. 2A-FIG. 2D. Electrical connections or lines for connection to the control device 12 are not shown here; however, the person skilled in the art will recognize that they are present. The person skilled in the art will also recognize that the display device 10 can have control electronics (not shown). The display device 10 is designed such that its user interface 10a extends over the edges between a fixed region of the end face 30 and a fixed region of the door leaf 26. In one exemplary embodiment, the display device 10 has an end face segment 6 and a door leaf side segment 8 which, in the exemplary embodiments shown, are arranged at an angle to one another, substantially at right angles; this is shown in particular in the plan view in FIG. 2D. These can be two separate segments 6, 8 (individual display devices) which are connected to one another at or in the region of the edge and are controlled by the control device 12 or the control electronics of the display device 10 in such a way that the information display is displayed extending across the edges. In another embodiment, a (single or one-piece) curved display device can include the segments 6, 8, as explained elsewhere in the present description.

From the plan view shown in FIG. 2D, it is moreover apparent that the segments 6, 8 in the exemplary embodiments shown (in the x-direction and y-direction) are of different lengths (L-shaped arrangement), with the shorter segment 6 extending in the y-direction on the end face and the longer segment 8 extending in the x-direction on the door leaf side. In the z-direction, the segments 6, 8 have the same length. In another exemplary embodiment, the segments 6, 8 can be of the same length in the x-direction and y-direction, or the end face segment 6 can be longer than the segment 8 on the door leaf side. In one embodiment, the segments 6, 8 can be longer in the z-direction than in the x-direction and y-direction, so that a display device 10 arranged vertically is obtained. The dimensions of the display device 10, in particular the size of the segments 6, 8, can be determined depending on the type of building and/or the scope of the information to be displayed.

From the representations of FIG. 2A-FIG. 2D, it can also be seen that the display device 10 or its user interface 10a extends across the edges. In other words, the user interface 10a ends, at the end face or door leaf side, not at or in front of the edge between the door leaf 26 and the end face 30 in order then to start again as an as it were new, second user interface 10a on the other side at this edge; it is rather a user interface 10a which covers the edge, encloses it, and starts on the one side and continues on the other side of the edge. In one embodiment, the display device 10, which in particular is bent as one piece, has a light-emitting diode mesh (also known as LED mesh or LED fabric) or a flexible light-emitting diode screen (LED (display) unit), in particular made up of LEDs mounted on a flexible carrier material (flexible board), which in turn is embedded in a fabric. Flexible display devices can also include organic LEDs (OLEDs), resulting in one OLED unit each; these can also be designed as touch-sensitive display devices, whose structures and modes of operation, including information on electronic controlling, are known for example from US 2017/0336831 A1 and WO 2013/048881 A1. In another exemplary embodiment, the display device 10 includes an LCD unit, which can also be designed to extend across the edges.

In one embodiment, the display device 10 has a glass or plastic surface which extends over the user interface 10a. The glass or plastic surface may be shaped to extend seamlessly over the segments 6, 8 and a curvature therebetween, as shown in the embodiments of FIG. 2A-FIG. 2D. So that the information display can be perceived by a user, the glass or plastic surface is transparent to visible light. In addition, the glass or plastic surface can be designed such that the display device 10 can be designed as touch-sensitive display devices. In addition to these properties, the glass or plastic surface protects the display device 10 from damage and enables easy cleaning. Methods for producing glass or plastic surfaces with the stated properties are known to the person skilled in the art.

In the technology described herein, the display device 10 is used to display information, which information may inform a user, for example, about the status of the sliding door 4, about its use, and/or about a condition of the building or of the zone 21, 22 separated by the sliding door 4. The information can be represented by pictograms, symbols, and/or text; pictograms or symbols can for example provide the information that the sliding door 4 is locked, that the sliding door 4 is unlocked, that certain actions are undesirable or prohibited (e.g. smoking or telephoning) and that access is not permitted. Text, alone or in combination with a pictogram or symbol, can be, for example, an instruction or direction (e.g. “Please touch,” “Please wait,” “No access,” “Do not disturb,” “Emergency exit,” “Escape route,” “Fire alarm,” or the like), or can display the name of the user. In addition, in one embodiment an audible signal and/or a voice message corresponding to the pictogram or symbol can be initiated.

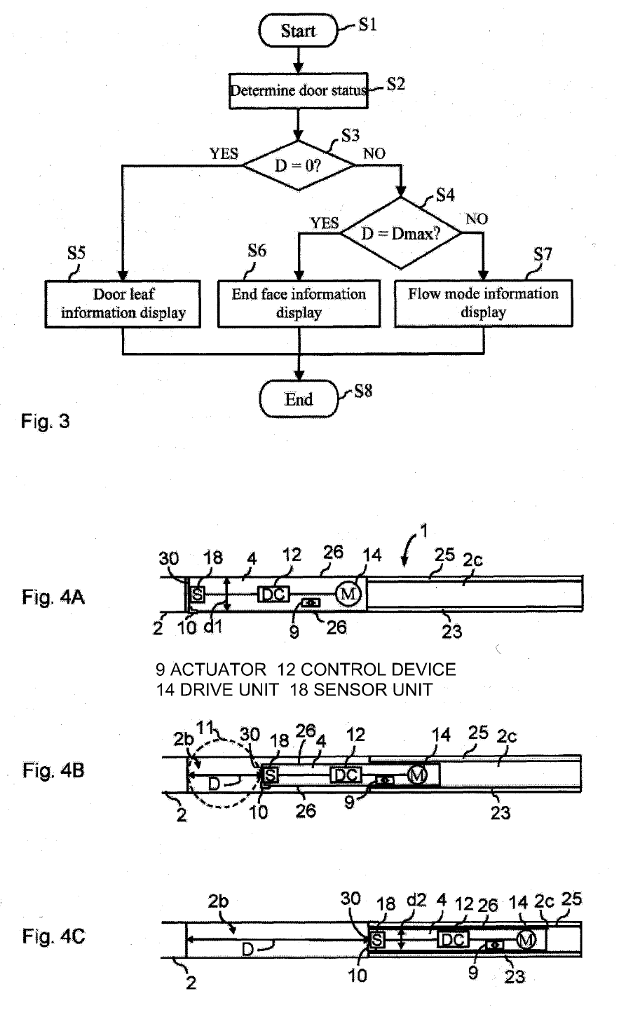

When the sliding door 4 is in the closed position, the display device 10 is controlled in such a way that information on the door leaf segment 8 is displayed as shown in FIG. 2A. The end face segment 6, which is concealed substantially by the door frame region 2a in the closed position, is not actuated in this case. In FIG. 2C the sliding door 4 is in the open position and the display device 10 is controlled in this exemplary embodiment such that information is displayed on the end face segment 6. Between these two positions of the sliding door 4, the display device 10 is controlled in such a way that information is displayed on the end face segment 6 and/or the door leaf segment 8, as shown by way of example in FIG. 2B. In one embodiment, the controlling takes place such that when the sliding door 4 enters the wall shell region 2c, the information display is perceived by the user as if the information display were being “pushed” forward by the wall shell region 2c, as if the display content were stationary while the sliding door 4 continues to move; in conjunction with the flowchart shown in FIG. 3, this is illustratively referred to as flow mode. In one exemplary embodiment, this flow mode begins when the distance D reaches or exceeds the defined threshold value; in one embodiment, this threshold value is 80%, i.e. the sliding door 4 is 80% open. Up to this 80% door opening (e.g. until the display device 10 begins to disappear into the wall shell region 2c), in this embodiment the door leaf side segment 8 remains active and displays the information. The flow process does not begin until shortly before the sliding door 4 is completely open. The person skilled in the art will recognize that the flow process with respect to the information display can take place during the entire opening process or only towards the end of the opening process. The person skilled in the art will also recognize that a different threshold value can be selected depending on the type and use of the building or the sliding door 4. The person skilled in the art will recognize that, analogously to the opening process, during the closing process the information display can be moved from the end face segment 6 to the door leaf side segment 8; for example, the movement can begin when the threshold value (80%) is reached during the closing process.

As mentioned above, the controlling of the display device 10 or its user interface 10a in order to display information takes place as a function of a determined position of the sliding door 4, in particular as a function of the distance D. In an exemplary embodiment, a rotary encoder integrated in the drive unit 14 (motor) can be used to determine the position of the sliding door 4, or the distance D. Rotary encoders (also called incremental encoders or encoders) are known to a person skilled in the art and may be configured to detect angle changes and a direction of rotation. If the motor rotates to move the sliding door 4, each change of angle by a defined angle to the left or to the right results in a defined change of a manipulated variable (e.g. a distance traveled by the sliding door is increased or decreased by one (increment (+1) or decrement (−1))); given known values for the closed position and the open position of the sliding door 4, the (distance D) can be determined from the change of angle or the distance traveled. The values for the closed position and the open position of the sliding door 4 can be determined, for example, when the sliding door 4 is put into operation in an initialization run.

In one embodiment, the sensor unit 18 can be used to determine the position of the sliding door 4, or the distance D. The sensor unit 18 is connected to the control device 12 by an electrical connection 32 and is arranged in a region of the end face 30 of the sliding door 4. The arrangement of the sensor unit 18 can be selected such that the passage region 2b can be monitored and the distance D can be determined. The monitoring can detect whether the passage region 2b is free, i.e. neither a user nor an obstacle is located there, and the sliding door 4 can be closed. The arrangement is selected such that for example electromagnetic radiation (light or radio waves) emitted by the sensor unit 18 can propagate unhindered towards the passage region 2b during operation. If the sensor unit 18 has a camera which detects in the infrared or visible electromagnetic spectrum, the arrangement can be selected such that the passage region 2b is located in the “field of view” of the camera. The sensor unit 18 can, for example, be inserted into a recess in the end face 30 and protected from damage and dirt by a radiation-permeable cover. In order to determine the distance D, the sensor unit 18 can additionally be arranged at a height so that, under normal circumstances, no obstacle or user is located between the sensor unit 18 and the door frame region 2a.

For these functions, the sensor unit 18 may have one or more sensors, for example one or more sensors or 3D cameras based on the principle of light runtime measurement (time of flight or TOF sensor). Such a 3D camera includes a light-emitting diode unit or laser diode unit which, for example, emits light in the infrared range, wherein the light is emitted in short pulses (e.g., several tens of nanoseconds). The 3D camera also includes a sensor group consisting of a number of light-sensitive elements. The sensor group is connected to a processing chip (e.g., a CMOS sensor chip), which determines the time of flight of the emitted light. The processing chip simultaneously measures the distance to a number of target points in space in a few milliseconds. The 3D camera can also be based upon a measuring principle according to which the time-of-flight of emitted light is captured via the phase of the light. The phase position when the light is emitted and when it is received is compared, and the time elapsed or the distance to the reflecting object is determined therefrom. For this purpose, a modulated light signal is preferably emitted, instead of short light pulses. Further details of these measurement designs are given for example in the following publications: “Fast Range Imaging by CMOS Sensor Array Through Multiple Double Short Time Integration (MDSI),” P. Mengel et al., Siemens A G, Corporate Technology Department, Munich, Germany, and “A CMOS Photosensor Array for 3D Imaging Using Pulsed Laser,” R. Jeremias et al., 2001 IEEE International Solid-State Circuits Conference, p. 252.

In another exemplary embodiment, the functionality of the sensor device 18 and the functionality of the display device 10 can be combined in one device; for example, the functionality of the sensor device 18 can be implemented in the display device 10, as shown in FIG. 2D. For the functionality of the sensor device 18, the 3D camera can be arranged, for example, at the end face below the glass or plastic surface of the display device 10. In one embodiment, at least one further device for further functionality can be implemented in the display device 10. FIG. 2D shows an embodiment with several such devices, shown as examples are a video camera 10d for a door peephole function and/or for capturing an optical code (e.g. a bar code, a matrix code (QR code)), a radio unit 10b, 10c (e.g. according to a standard for RFID or Bluetooth technologies) for capturing a proof of authorization and/or for communicating with a user's cell phone, a speaker 10e, a proximity sensor 10f for detecting an approaching user, and/or an LED lighting device 10g for illuminating the display device 10 and/or a surrounding area of the sliding door 4. These devices can be connected to the control device 12 via an interface device. Alternatively, the devices can be connected exclusively or additionally to the control electronics of the display device 10 in order to be controlled by the latter and/or to communicate with it. The named devices and their functioning are known to the person skilled in the art, so that further explanations thereof do not appear to be necessary at this point.

With the understanding of the basic system components described above and their functions, a method, by way of example, for operating the access building sliding door system 1, proceeding from the situation shown in FIG. 1, is described below in conjunction with FIG. 3. The method shown in FIG. 3 begins with a step S1 and ends with a step S8. The person skilled in the art will recognize that the division into these steps is by way of example, and that one or more of these steps may be divided into one or more sub-steps, or that several of the steps may be combined into one step.

In a step S2, the status of the sliding door 4 is determined. As stated above, the rotary encoder can be used, for example, to determine the distance D of the end face 30 from the door frame area 2a. This yields the status of the sliding door 4: sliding door 4 closed (D=0), fully open (D=Dmax) or partially open (0<D<Dmax).

In a step S3, it is checked whether the sliding door 4 is closed, i.e. D=0. If this is the case, the method proceeds along the YES branch to a step S5. When the sliding door 4 is closed, the information is displayed on the door leaf side in step S5. The control device 12 controls the display device 10 accordingly for this purpose.

If this check concludes in step S3 that the sliding door 4 is not closed, the method proceeds along the NO branch to a step S4. In step S4, it is checked whether the sliding door 4 is fully open, i.e. D=Dmax. If this is the case, the method proceeds along the YES branch to a step S6. When the sliding door 4 is completely open, in step S6 the information display takes place at the end face. The control device 12 controls the display device 10 accordingly for this purpose.

If, in contrast, this check concludes in step S4 that the sliding door 4 is not fully open, the method proceeds along the NO branch to a step S7. The sliding door 4 is therefore neither closed nor fully open. In this status of the sliding door 4, the information display in step S7 is performed in the flow mode (referred to here as an example) in which the information display is moved from one segment 6, 8 to the other segment 6, 8. In FIG. 3, the method ends in step S8.

The person skilled in the art will recognize that the status of the sliding door 4 changes, for example, when it is actuated by a user, for example in order to open it. If the sliding door 4 is then fully open, it can remain in the fully open position for a defined period of time and then close automatically.

Referring again to FIG. 1, in the following a description is given of further details of the mechanical design of the frame structure 2 and of the sliding door 4. The door frame region 2a is located on the left of the passage region 2b, it also being possible for it to extend over the passage region 2b, and the wall shell region 2c is located on the right of the passage region 2b, it also being possible for it to extend over the passage region 2b. The passage region 2b is thus surrounded by the door frame region 2a, the wall shell region 2c and a building floor or a threshold or guide rail arranged there.

A wall panel 25 (hereafter referred to as wall inner panel 25) facing the interior zone 21, a wall panel 23 (hereafter referred to as wall outer panel 23) facing the exterior zone 22, and lateral fastening devices 17 are arranged on the frame structure 2. The wall inner panel 25 is arranged substantially parallel to the wall outer panel 23, wherein the wall panels 23, 25 in particular cover (clad) the door frame region 2a and the wall shell region 2c and their look can be harmonized with the surrounding wall. The lateral fastening devices 17 are provided for connecting the building sliding door system 1 to the building. In relation to the x-y-z coordinate system shown in FIG. 1, the building sliding door system 1 has a length in the x direction, a depth in the y direction, and a height in the z direction; the building sliding door system 1 extends in a plane which is spanned by the x and z axes. The sliding door 4 can be moved in the x-direction along a movement axis. In the illustration shown in FIG. 1, the movement axis corresponds to the x-axis; the movement axis therefore has the reference sign x (movement axis x) in this representation.

The wall shell region 2c has a cavity between the wall panels 23, 25, which cavity is dimensioned such that it at least partially receives the sliding door 4 in the open position. The sliding door 4 has two substantially parallel door leaves 26 (on an inner side and an outer side, respectively, of the sliding door 4) and the end face 30 which points in the direction of the passage region 2b and extends transversely to the movement axis x. Starting at the end face 30, the door leaves 26 extend substantially parallel to the movement axis x and are spaced apart from one another (in the y-direction) such that there is an inner space between the door leaves 26 in which system components and insulating material, e.g. for soundproofing and fire protection, can be arranged. Each of the door leaves 26 extends parallel to the x-z plane and terminates at an opposite end face 31.

In the exemplary embodiment shown in FIG. 1, the building sliding door system 1 is connected to the building control system 20 (BM) by means of an electrical connection 28. The building sliding door system 1 is supplied with electrical energy, for example, via this connection 28. In an exemplary embodiment, operation of the building sliding door system 1 can be ensured by the supplied energy without external control signals or control commands being supplied thereto. In this exemplary embodiment, system components which check for example a key, an access code, or another type of access authorization are integrated (locally) in the building sliding door system 1 such that it can be operated autonomously, apart from the electrical energy.

The control device 12 is also connected to the drive device 14 and the interface device 16 by means of an electrical connection 34. The electrical connection 32 between the sensor unit 18 and the control device 12 and the electrical connection 34, but also the electrical connection 33 between the control device 12 and the display device 10, run within the sliding door 4, for example between the door leaves 26. The electrical connections 32, 33, 34 are designed for signal and/or energy transmission; for this purpose, they can each have individual electrical lines or an electrical bus system.

In an exemplary embodiment, external control signals or control commands can be supplied to the building sliding door system 1, for example in connection with checking an access authorization. In this exemplary embodiment, the electrical interface device 16 is in addition provided for communication between the building control system 20 and the building sliding door system 1. For this purpose, the electrical connection 28 has a communication network to which the building control system 20 and the interface device 16 are coupled. The building control system 20 may have a computer-assisted building management system in which data of access-authorized users and objects are stored.

A person skilled in the art will recognize that the building control system 20 can be arranged in the building, wherein the building control system 20 is designed as a local unit, which is independent of an external system, for operating the building sliding door system 1 (or also several such systems). In an exemplary embodiment, functions of the building control system 20 can be distributed in subsystems or components arranged locally in and remote from the building. For this purpose, the subsystem arranged in the building can be coupled to an IT infrastructure for so-called cloud computing (colloquially also referred to as the “cloud”). This includes, for example, storing data in a remote data center but also executing programs that are installed remotely rather than locally. Depending upon the design, a certain functionality can be made available, for example, in the control device 12 or via the “cloud.” For this purpose, a software application or program parts thereof can be executed in the “cloud,” for example. The control device 12 then accesses this infrastructure via the interface device 16, as required, in order to execute the software application.

In a system embodiment, the electrical connection 28 can have an electrical bus system. In an exemplary embodiment, the electrical connection of the sliding door system 1, including its supply with electrical energy, is made via the interface device 16. A person skilled in the art will recognize that several sliding door systems 1 can be provided in the building, and that each of these building sliding door systems 1 can be coupled to the electrical connection 28, in order to communicate with the building control system 20, for example, in connection with determining and checking access authorizations if this is done centrally by the building control system 20.

In the following, the functioning of the building sliding door system 1 is described with reference to FIGS. 4A-4C. FIGS. 4A-4C each show a schematic representation of a horizontal cross-section of an exemplary embodiment of the building sliding door system 1 with the sliding door 4. Each of these views shows the components which the sliding door 4 includes: sensor unit 18 (S), control device 12 (DC), display device 10 and drive unit 14 (M); for the purpose of illustration, the interface device 16 and the connection thereof to the building control system 20 are not shown. The drive unit 14 and the control device 12 are arranged inside the sliding door 4, and in particular between the door leaves 26.

The shown exemplary embodiment of the sliding door 1 is based upon a principle that is similar to a principle known from EP 2 876 241 A1. A sliding door system is described therein in which two opposite door surfaces are coupled to an actuator which moves the door surfaces towards or away from one another. In relation to the sliding door system 1 according to the technology described here, this means that the two door leaves 26 have a leaf spacing d1 when the sliding door 4 is in the closed position (FIG. 4A). During the opening of the sliding door 4, the two door leaves 26 are moved towards one another by means of an actuator 9 (FIGS. 4A-4C) until they have a leaf spacing d2 which is dimensioned such that the sliding door 4, when in its fully open position FIG. 4C or partially open position (FIG. 4B and area 11), has such a small thickness that it fits into the accommodating structure of the wall shell region 2c. The leaf spacing d1 is greater than the leaf spacing d2. When the sliding door 4 is pushed out of the wall shell region 2c, the two door leaves 26 are moved away from one another (spread apart) such that the sliding door 4 when closed (FIG. 4A) assumes a defined thickness. The thickness is set so that the outer sides of the two door leaves 26, in the closed position, are essentially flush with the outer sides of the wall shell region 2c or the cladding thereof (wall panels 23, 25). As a result, a substantially smooth finish is achieved on both wall sides in the door region.

In an exemplary embodiment, the building sliding door system 1 has, on a door transom, a guide device which bears the sliding door 4 and guides it on its path between the closed position and the open position. The sliding door 4 has a complementary device on its upper edge. The guide device and the complementary device interact when the drive unit 14 causes the sliding door 4 to move and, for example, acts on the complementary device. The guide device and the complementary device form, for example, a roller mechanism (for example a roller-mounted carriage system (roller carriage). The drive unit 14 can include, for example, a motorized or pneumatic sliding drive which acts, for example, on the sliding door 4. A person skilled in the art will recognize that the embodiment is not limited to a roller mechanism, and that the guide device and the complementary device can be designed in a different manner, for example as a telescopic extension.

In an exemplary embodiment, the two door leaves 26 are moved towards or away from one another by the actuator 9. The actuator 9 can include a spreading device which is activated mechanically, electrically, or electro-mechanically. The spreading device is designed to move the door leaves 26 towards one another when the sliding door 4 is to be opened, and to move them away from one another when the sliding door 4 is to be closed. A person skilled in the art would recognize that other spreading devices can also be provided instead—for example, cylinders actuated by a pressure medium.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A building sliding door system separating a first building region from a second building region, the building sliding door system comprising:
a frame structure having a door frame region, a passage region and a wall shell region;
a sliding door movable along a movement axis in the frame structure between a closed position closing the passage region and an open position opening the passage region, the sliding door having an end face and a door leaf, wherein the wall shell region at least partially receives the sliding door in the open position, wherein the end face points in a direction of the passage region and extends transversely to the movement axis, and wherein the door leaf, starting from the end face, extends parallel to the movement axis;
a drive unit acting on the sliding door;
a control device controlling the drive unit to move the sliding door along the movement axis;
a display device arranged in a fixed vertical section on the sliding door and connected to the control device, wherein the display device has a user interface extending across an edge of the sliding door between a region of the end face and a region of the door leaf; and
wherein the control device controls the display device to display information on a segment of the user interface at the door leaf region and/or a segment of the user interface at the end face region.

17. The building sliding door system according to claim 16 wherein the control device controls the display device information display as a function of a determined position of the sliding door, the information being displayed on the segment at the door leaf region when the sliding door is in the closed position, the information being displayed on the segment at the end face region when the sliding door is in the open position, and the information being displayed on the door leaf region segment and/or on the end face region segment when the sliding door is in an intermediate position between the closed position and the open position.

18. The building sliding door system according to claim 16 wherein the drive unit includes a rotary encoder that detects an angle change when the sliding door is moved by the drive unit, the control device determining from the detected angle change a distance between the end face and the door frame region for controlling the display device.

19. The building sliding door system according to claim 16 including a sensor unit arranged on the sliding door and connected to the control device, wherein the sensor unit determines a distance between the end face and the door frame region and the control device determines from the distance a position of the sliding door along the movement axis for controlling the display device.

20. The building sliding door system according to claim 19 wherein the sensor unit and the display device are combined in one unit.

21. The building sliding door system according to claim 20 including at least one further device implemented in the display device, the at least one further device being one of a video camera for performing a door peephole function and/or for detecting an optical code, a radio unit for detecting a proof of authorization and/or for communicating with a mobile telephone of a user, a loudspeaker, a proximity sensor for detecting an approaching user, and an LED lighting device for illuminating the display device and/or an environment of the sliding door.

22. The building sliding door system according to claim 16 wherein the display device comprises, in order to display the information, an LED unit, an OLED unit or an LCD unit.

23. The building sliding door system according to claim 22 wherein each of the units is flexible and extends across the edge of the sliding door.

24. The building sliding door system according to claim 16 wherein the display device user interface is touch-sensitive to enable a user to enter information into the control device.

25. The building sliding door system according to claim 16 wherein the display device has a glass or plastic surface that extends over the user interface and the glass or plastic surface is transparent to visible light.

26. The building sliding door system according to claim 16 wherein the door leaf includes an outer door leaf and an inner door leaf spaced apart, the sliding door having an actuator that moves the inner and outer door leaves towards one another during an opening movement of the sliding door, wherein a thickness of the sliding door is reduced to be accommodated by the wall shell region, and the actuator moves the inner and outer door leaves away from one another during a closing movement of the sliding door, wherein the thickness of the sliding door is increased.

27. A method for operating the building sliding door system according to claim 16, the method comprising the steps of:
operating the control device to control the drive unit to move the sliding door along the movement axis; and
operating the control device to control the display device to display information on the user interface at the door leaf and/or at the end face.

28. The method according to claim 27 including determining a position of the sliding door along the movement axis and activating the display device to display the information as a function of the determined position of the sliding door, wherein the information display is on the door leaf in the closed position of the sliding door, on the end face in the open position of the sliding door, and on the door leaf and/or on the end face in an intermediate position of the sliding door.

29. The method according to claim 28 including using a rotary encoder present in the drive unit to determine the position of the sliding door, the rotary encoder detecting an angle change when the sliding door is moved by the drive unit, the control device determining from the detected change in angle the position of the sliding door.

30. The method according to claim 29 wherein the position of the sliding door is determined as a distance between the end face and the door frame region.

31. The method according to claim 28 including using a sensor unit arranged on the sliding door to determine the position of the sliding door, the sensor unit being connected to the control device and detecting the door frame region.

32. The method according to claim 31 wherein the position of the sliding door is determined as a distance between the end face and the door frame region.

33. The method according to claim 28 including operating the display device to display the information in a flow mode when a distance between the end face and the door frame region reaches or exceeds a defined threshold value.

34. The method according to claim 33 including displaying the information on the door leaf until the defined threshold value is reached.
